(19) United States
(12) Patent Application Publication
(10) Pub. No.: US 2022/0284364 A1
(43) Pub. Date: Sep. 8, 2022

(54) MULTI-PRODUCT PRODUCTION PLANNING METHOD AND DEVICE, COMPUTER EQUIPMENT AND STORAGE MEDIUM

(71) Applicant: BOE Technology Group Co., Ltd., Beijing (CN)

(72) Inventors: Jifang HAO, Beijing (CN); Xibo ZHOU, Beijing (CN)

(21) Appl. No.: 17/552,961

(22) Filed: Dec. 16, 2021

(30) Foreign Application Priority Data
Mar. 8, 2021 (CN) 202110249921.1

(51) Int. Cl. G06Q 10/06; G06Q 10/04

(52) U.S. Cl. CPC G06Q 10/06311; G06Q 10/04

(57) ABSTRACT

The present application disclose a multi-product production planning method and device, computer equipment and storage medium. The method includes: obtaining production information, where the production information includes a maximum demand for each kind of products in a variety of kinds of products, at least two kinds of products have at least one identical production material, and the production materials of at least one kind of products include replaceable production materials marked with priorities; establishing a linear programming model having a goal and constraint conditions according to the production information; and solving the linear programming model to obtain a production planning scheme.

### CROSS-REFERENCE TO RELATED APPLICATIONS

The present application claims a priority to the Chinese patent application No. 202110249921.1, filed in China on Mar. 8, 2021, a disclosure of which is incorporated herein by reference in its entirety.

### TECHNICAL FIELD

The present application relates to the field of product production planning technologies, and in particular to a multi-product production planning method and device, a computer equipment and a storage medium.

### BACKGROUND

In production processes of a variety of products, generally speaking, each product requires a variety of production materials in different amounts. A common situation is that there is an intersection of production materials required for different products. Then, in case of a fixed inventory of production materials, in order to satisfy an order of each product to the greatest extent, a multi-product production planning is required. The production planning in the related art is to manually plan and calculate according to production information such as an inventory of production materials and product orders, which has problems such as low accuracy, low efficiency and difficulty in dealing with more complex scenarios.

### SUMMARY

In a first aspect, one embodiment of the present application provides a multi-product production planning method, executed by a computer equipment, including:

obtaining production information; wherein the production information includes a maximum demand for each kind of products in a variety of kinds of products, types and quantities of production materials of a single piece of each kind of products, and an inventory of each production material; among the variety of kinds of products, at least two kinds of products have at least one identical production material, and the production materials of at least one kind of products include replaceable production materials marked with priorities;

establishing a linear programming model having a goal and constraint conditions according to the production information; wherein the goal of the linear programming model is to maximize a total output of multiple kinds of products, and the constraint conditions of the linear programming model include: usage amount of each production material is less than or equal to an inventory; an output of each kind of products is less than or equal to a maximum demand, wherein for one kind of products having production materials including replaceable production materials, a total output of the one kind of products produced based on each replaceable production material is less than or equal to the maximum demand; for one kind of products having production materials including replaceable production materials, outputs of products produced based on various replaceable production materials are decreased from high to low according to priorities of the replaceable production materials; and

solving the linear programming model to obtain a production planning scheme.

Optionally, the production information further includes a weight of each kind of products, and an objective function of the linear programming model is:

$$max {\sum }_{i = 1}^{n} {w}_{i} * {x}_{i}$$

wherein wᵢ represents a weight of an i-th product; xᵢ represents an output of the i-th product; n represents the number of kinds of product.

Optionally, the establishing a linear programming model, includes: dividing kinds of products without intersection of production materials into different groups, and establishing a linear programming model corresponding to each group.

Optionally, the linear programming model is a mixed integer programming model.

Optionally, the solving the linear programming model, includes:

solving the mixed integer programming model and determining whether an output of each kind of products in an obtained initial solution is an integer;

if yes, ending calculation procedure;

if not, selecting one of non-integer outputs in the initial solution in turn and performing a branch solution until an output of each kind of products is an integer; wherein when performing each branch solution, a total output value in a solution obtained in a previous branch solution is set as an upper limit of a maximum total output, and the remaining non-integer output is re-solved according to an adjacent integer value of the selected non-integer output.

Optionally, the obtaining production information, includes: reading the production information from a database.

Optionally, before the obtaining production information, the method further includes: updating the production information in the database.

In a second aspect, one embodiment of the present application provides a computer equipment, including: a memory, a processor, and a computer program stored on the memory and executable on the processor, wherein the processor executes the computer program to implement the multi-product production planning method in the first aspect.

In a third aspect, one embodiment of the present application provides a computer-readable storage medium, including a computer program stored thereon, wherein the program is executed by a processor to implement the multi-product production planning method in the first aspect.

Additional aspects and advantages of the present application will be given in the following description, which will become apparent from the following description, or be understood through practice of the present application.

### BRIEF DESCRIPTION OF THE DRAWINGS

The foregoing and/or additional aspects and advantages of the present application will become apparent and easy to understand from the following description of the embodiments in conjunction with the accompanying drawings, in which:

FIG. 1 is a schematic flow chart of a multi-product production planning method according to an embodiment of the present application;

FIG. 2 is a schematic diagram showing a solving process of a mixed integer programming model according to an embodiment of the present application;

FIG. 3 is a schematic diagram of a multi-product production planning device according to an embodiment of the present application; and

FIG. 4 is a schematic diagram of a computer system for implementing a multi-product production planning method according to an embodiment of the present application.

### DETAILED DESCRIPTION

Reference will now be made in detail to the exemplary embodiments of the present application, examples of which are illustrated in the accompanying drawings, wherein the various details of the embodiments of the present application are included to facilitate understanding and are to be considered as exemplary only. Accordingly, a person skilled in the art should appreciate that various changes and modifications can be made to the embodiments described herein without departing from the scope and spirit of the present application. Also, descriptions of well-known functions and structures are omitted from the following description for clarity and conciseness.

In production processes of a variety of products, generally speaking, each product requires a variety of production materials in different amounts. A common situation is that there is an intersection of production materials required for different kinds of products. As a simple example, the production of a product E requires five production materials e1 and two production materials e2 (which may be expressed as E=5e1+2e2); and the production of a product F requires two production materials e1, three production materials e2 and one production material f1 (which may be expressed as F=2e1+3e2+f1); then, the products E and F have an intersection of production materials e1 and e2. In this way, in case of a fixed inventory of production materials, that is, when the quantities of the production materials e1, e2 and f1 are fixed, in order to maximize a total output of the products E and F, a multi-product production planning is required. The production planning in the related art is to manually plan and calculate according to production information such as an inventory of production materials and product orders, which has problems such as low accuracy, low efficiency and difficulty in dealing with more complex scenarios.

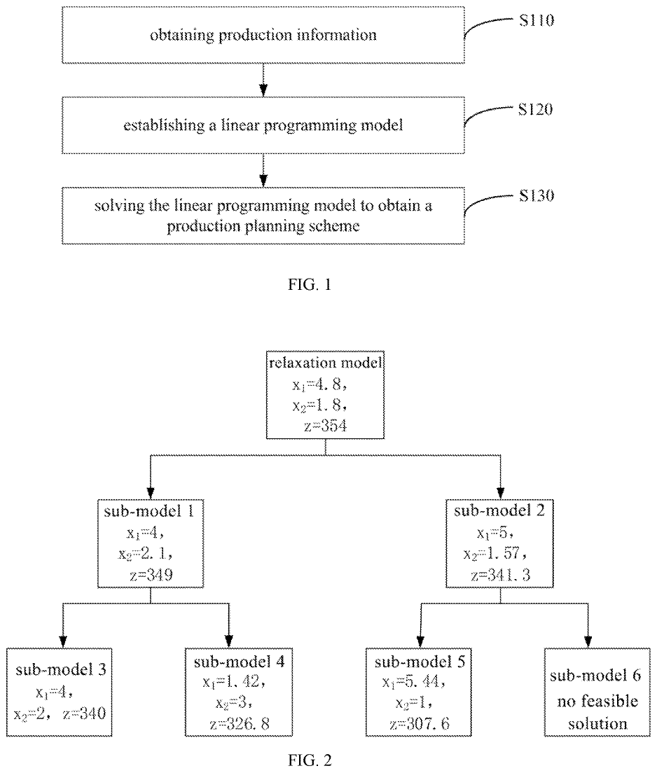

In view of this, as shown in FIG. 1, one embodiment of the present application provides a multi-product production planning method, which is executed by a computer apparatus. The method includes the following steps.

Step S110: Obtaining Production Information.

The production information includes a maximum demand for each kind of products in a variety of kinds of products, types and quantities of production materials of a single piece of each kind of products, and an inventory of each production material. Among the variety of kinds of products, at least two kinds of products have at least one identical production material, and the production materials of at least one kind of products includes replaceable production materials marked with priorities.

In one specific example, the production information is stored in a database, and is updated by a management system of the database according to product orders and material receipts obtained through online reception or manual input. The computer equipment reads the production information from the database when executing the production planning method.

It should be noted that the production materials of at least one kind of products including replaceable production materials marked with priorities should be understood as that: among a variety of kinds of products, the production materials of at least one kind of products have replaceable production materials. For example, there are five kinds of products to be produced, production materials of three kinds of products are all mandatory production materials (which are irreplaceable production materials), production materials of other two kinds of products replaceable production materials, and one of these two kinds of products is a product G. Production materials of the product G include production materials g₁, g₂, g₃, g₄ and g₅.

For example, the production materials g₂ and g₃ are replaceable production materials, and the production materials g₂ and g₃ can replace each other, and only one of the production materials g₂ and g₃ is sufficient; when not considering quantities of production materials used to produce a single product, it can be expressed as G₁=g₁+g₂+g₄+g₅, G₂=g₁+g₃+g₄+g₅, where G₁ and G₂ may be understood as products derived from the product G, and are all belong to the product G. That is, the product G includes two derivative products G₁ and G₂ based on different replaceable production materials. For the product G, priority relationship between the two derivative products G₁ and G₂ may be determined based on priority relationship between the replaceable production materials g₂ and g₃, for example, priority g₂>g₃, then G₁>G₂. It should be noted that one possible situation is that the replaceable production materials g₂ and g₃ of the product G are also used as replaceable production materials for other products such as a product H; in this case, for the product G and product H, priorities of the replaceable production materials g₂ and g₃ may be not necessarily the same.

For another example, the production materials g₁, g₂ and g₃ are replaceable production materials, the production materials g₁, g₂ and g₃ can replace each other, and only one of the production materials g₁, g₂ and g₃ is sufficient; when not considering quantities of production materials used to produce a single product, it can be expressed as G₁=g₁+g₄+g₅, G₂=g₂+g₄+g₅, G₃=g₃+g₄+g₅. That is, the product G includes three derivative products G₁, G₂ and G₃ based on different replaceable production materials.

For another example, the production materials g₁, g₂, g₃ and g₄ are replaceable production materials, the production materials g₁ and g₂ can replace each other, and the production materials g₃ and g₄ can replace each other; that is, the product G includes two groups of replaceable production materials; when not considering quantities of production materials used to produce a single product, it can be expressed as G₁=g₁+g₃+g₅, G₂=g₁+g₄+g₅, G₃=g₂+g₃+g₅, G₄=g₂+g₄+g₅. That is, the product G includes four derivative products G₁, G₂, G₃ and G₄ based on different replaceable production materials. For the product G, priorities of the four derivative products G₁, G₂, G₃ and G₄ may be determined based on priority relationship between the replaceable production materials g₁ and g₂ and priority relationship between the production materials g₃ and g₄. For example, a priority of one group of replaceable production materials (g₁, g₂) is higher than a priority of the other one group of replaceable production materials (g₃, g₄), i.e., (g₁, g₂)>(g₃, g₄); a priority of the production material g₁ is higher than a priority of the production material g₂, i.e., g₁>g₂; a priority of the production material g₃ is higher than a priority of the production material g₄, i.e., g₃>g₄; then, when determining the priorities of derivative products, it is to first determine whether there is the production material g₁ or the production material g₂; and then whether there is the production material g₃ or the production material g₄; and the priorities of derivative products G₁, G₂, G₃ and G₄ are G₁>G₂>G₃>G₄.

In addition, in a variety of kinds of products, if there is one kind of produces which is made of only one production material, the production material of the one kind of produces may be either a replaceable production material or a mandatory production material.

In a multi-product production scenario, various kinds of products may have differences in proximities of delivery deadlines, importance of products in subsequent industry chains and selling prices, thus, in one possible implementation, the production information further includes a weight of each kind of products, which may also be referred as an important index of each kind of products.

In one specific example, the obtained production information is production information in the current production cycle, and specifically includes: identification codes (such as ID) or product names of all kinds of products, identification codes (such as ID) or names of production materials required for each kind of product, amounts of production materials for a single product (that is, an amount of each production material required to produce a product), identifier of whether one production material is a mandatory production material or a replaceable production material for each kind of product, a priority of one replaceable production material for each kind of product, an inventory of each production material, an inventory of production materials of a signal piece of each kind of products, and a maximum demand and weight of each kind of products.

For example, the following table 1, table 2 and table 3 together show the obtained production information.

TABLE 1

| Product | Production | Material | Replacement |
|---|---|---|---|
| ID | material ID | quantity/piece | priority |
| A | a₁ | 2 | 0 |
| A | a₂ | 5 | 0 |
| B | b₁ | 1 | 0 |
| B | b₂ | 3 | 1 |
| B | a₂ | 4 | 2 |

TABLE 2

| Product | maximum | |
|---|---|---|
| ID | demand | weight |
| A | 24689763 | 0.5 |
| B | 136942362 | 0.2 |

TABLE 3

| Production | |
|---|---|
| material ID | inventory |
| a₁ | 12345678 |
| a₂ | 23456789 |
| b₁ | 21456322 |
| b₂ | 53786105 |

As shown in the table 1, to-be-produced products include a product A and a product B. The production of one product A requires two production materials a₁ and five production materials a₂, and both of the production material a₁ and the production material a₂ are mandatory production materials for the product A, that is, A=2a₁+5a₂. The production of one product B requires one production material b₁ and three production materials b₂, or the production of one product B requires one production material b₁ and four production materials a₂; the production material b₁ is a mandatory production material for the product B; and the production materials b₂ and a₂ are replaceable production materials for the product B; and a priority of the production material b₂ is higher than a priority of the production materials a₂. Then, the product B includes two derivative products B₁ and B₂, where B₁=b₁+3b₂, B₂=b₁+4a₂, and a priority of the derivative product B₁ is higher than a priority of the derivative product B₂. In the table 1, the larger the value of the replacement priority, the higher the priority is. When the replacement priority of one production material is 0, it means that the one production material is mandatory for the corresponding product.

As shown in the table 2, in the current production cycle, a production task is that a maximum demand of the product A is 24689763, a weight of the product A is 0.5, a maximum demand of the product B is 136942362, and a weight of the product B is 0.2.

As shown in the table 3, an inventory of the production material a₁ is 12345678, an inventory of the production material a₂ is 23456789, an inventory of the production material b₁ is 21456322, and an inventory of the production material b₂ is 53786105.

S120: Establishing a Linear Programming Model.

The linear programming model is established according to the production information. A goal of the linear programming model is to maximize a total output of multiple products. Constraint conditions of the linear programming model include: usage amount of each production material is less than or equal to the inventory; an output of each kind of products is less than or equal to a maximum demand, where for one kind of products having production materials including replaceable production materials, a total output of the products produced based on each replaceable production material is less than or equal to the maximum demand; for one kind of products having production materials including replaceable production materials, outputs of products produced based on various replaceable production materials are decreased from high to low according to priorities of the replaceable production materials.

In one possible implementation, the output of the products is an integer, thus and the linear programming model may employ a mixed integer programming model.

In one possible implementation, an objective function of the mixed integer programming model is:

$$max {\sum }_{i = 1}^{n} {w}_{i} * {x}_{i}$$

where wᵢ represents a weight of an i-th product; xᵢ represents an output of the i-th product, a lower limit of xᵢ is 0, an upper limit of xᵢ is a maximum demand, and a value of xᵢ is a positive integer; n represents the number of kinds of product, 1≤i≤n.

In one specific example, constraint conditions of the above mixed integer programming model include three types. A first-type constraint condition includes that a usage amount of each production material is less than or equal to the inventory, which may be expressed with the following formula:

$${\sum }_{i = 1}^{n} {a}_{i , p} * {x}_{i} \leq {m}_{p}$$

where a_{i,p} represents an amount of a p-th production material required for a single product of an i-th kind of products; and mₚ represents an inventory of the p-th production material.

The second-type constraint condition includes that an output of each kind of products is less than or equal to a maximum demand, where for one kind of products having production materials including replaceable production materials, a total output of the products produced based on each replaceable production material is less than or equal to the maximum demand, which may be expressed with the following formula:

$${\sum }_{j = 1}^{k} {x}_{i , j} \leq {b}_{i}$$

where k represents the number of kinds of derivative products of products; x_{i,j} represents an output of a j-th derivative product of an i-th product; bᵢ represents a maximum demand for the i-th product. For one kind of products having production materials including replaceable production materials, an output of the one kind of products is a sum of outputs of derivative products produced based on various replaceable production material, and is less than or equal to the maximum demand of the one kind of products.

The third-type constraint condition includes that for one kind of products having production materials including replaceable production materials, outputs of products produced based on various replaceable production materials are decreased from high to low according to priorities of the replaceable production materials, which may be expressed with the following formula:

x_{i,1}≤x_{i,2}≤ . . . ≤x_{i,j}

where x_{i,1}, x_{i,2}, . . . x_{i,j}≥0, and they are integers. Priority relationship between the first derivative product to the j-th derivative product are the same as priority relationship of the replaceable production materials used by each of derivative products, and priorities of the first derivative product to the j-th derivative product are in an increasing order.

In summary, the mixed integer programming model may be formulated as:

$$max {\sum }_{i = 1}^{n} {w}_{i} * {x}_{i}$$

$$s . t . \\ {\sum }_{i = 1}^{n} {a}_{i , p} * {x}_{i} \leq {m}_{p}$$

$${\sum }_{i = 1}^{k} {x}_{i} \leq {b}_{i}$$

$${x}_{i , 1} \leq {x}_{i , 2} \leq … \leq {x}_{i , j}$$

$${x}_{i} \geq 0 , {x}_{i , 1} , {x}_{i , 2} , … , {x}_{i , j} \geq 0 , and are integers .$$

In one possible implementation, the establishing a mixed integer programming model, includes:

dividing kinds of products without intersection of production materials into different groups, and establishing a mixed integer programming model corresponding to each group.

By dividing kinds of products without intersection of production materials into different groups, this can reduce complexity of the model, increase calculation speed of solving the model and shorten the time to solve the model.

Continuing the previous example, establishing the mixed integer programming model corresponding to each group is mainly to group the number n of kinds of products in the objective function and the constraint conditions with the formula representation of the mixed integer programming model corresponding to each group remaining unchanged. In addition, this implementation may also be understood as establishing an overall model, and in a subsequent model solving stage, the number n of kinds of products are grouped and then solved separately.

S130: Solving the Linear Programming Model to Obtain a Production Planning Scheme.

In one possible implementation, solving the mixed integer programming model includes:

solving the mixed integer programming model and determining whether an output of each kind of products in an obtained initial solution is an integer;

if yes, ending the calculation procedure;

if not, selecting one of non-integer outputs in the initial solution in turn and performing a branch solution until an output of each kind of products is an integer; where when performing each branch solution, a total output value in a solution obtained in a previous branch solution is set as an upper limit of a maximum total output, and the remaining non-integer output is re-solved according to an adjacent integer value of the selected non-integer output.

In one specific example, as shown in FIG. 2, one procedure of solving the mixed integer programming model is, for example, as follows:

first, supposing that the formula of the mixed integer programming model is expressed as follows:

max z=40x₁+90x₂

s.t.

9x₁+7x₂≤56

7x₁+20x₂≤70

x₁, x₂≥0, and are integer.

When not considering integer limit, optimal solutions obtained after solving are x₁=4.8, x₂=1.8, z=354. Since x₁ and x₂ are not integers and do not conform to the integer programming, z=354 is set as an upper limit z̅ of optimal target value of the model. Since x₁=0, x₂=0 are a feasible solution, z=0 is set as a lower limit z* of optimal target value of the model, and then 0≤z*≤354.

x₁=4.8, x₂=1.8, i.e., x₁ and x₂ are not integers, and then one of x₁ and x₂ is selected to perform a branch solution. Assuming that x₁ is selected, it may be branched as x₁≤4, x₁≥5, then, the following are get:

Sub-Model 1:

max z=40x₁+90x₂

s.t.

9x₁+7x₂≤56

7x₁+20x₂≤70

0≤x₁≤4, x₂≥0

Sub-Model 2:

max z=40x₁+90x₂

s.t.

9x₁+7x₂≤56

7x₁+20x₂≤70

x₁≥5, x₂≥0

The following table 4 shows solution results of the sub-model 1 and the sub-model 2. It can be seen from the results that the optimal solution of the sub-model 1 is x₁=4, x₂=2.1, z=349; the optimal solution of the sub-model 2 is x₁=5. x₂=1.57, z=341.3; the optimal solution of the model will not exceed the maximum value of the optimal values of the sub-model 1 and the sub-model 2, and thus the delimitation is reset as 0≤z*≤349.

TABLE 4

| sub-model 1 | sub-model 2 |
|---|---|
| x₁ ≤ 4 | x₁ ≥ 5 |
| x₁ = 4, x₂ = 2.1, z = 349 | x₁ = 5, x₂ = 1.57, z = 341.3 |

In the solution results of the sub-model 1 and the sub-model 2, x₂ is a non-integer, and thus it is necessary to continue performing a branch solution. It may be branched according to the nearest integer of x₂. The sub-model 1 is decomposed into a sub-model 3 and a sub-model 4, and the sub-model 2 is decomposed into a sub-model 5 and a sub-model 6. The following table 5 shows solution results of the sub-models 3-6.

TABLE 5

| sub-model 3 | sub-model 4 | sub-model 5 | sub-model 6 |
|---|---|---|---|
| x₂ ≤ 2 | x₂ ≥ 3 | x₂ ≤ 1 | x₂ ≥ 2 |
| x₁ = 4, x₂ = 2, | x₁ = 1.42, x₂ = 3, | x₁ = 5.44, x₂ = 1, | no feasible |
| z = 340 | z = 326.8 | z = 307.6 | solution |

It can be seen from the table 5 that the sub-model 3 has an integer solution, and the optimal target value z* of the model will not be lower than this solution. Therefore, according to the sub-model 3, the upper limit of the optimal target value z* of the model is 340. The non-integer solutions of the sub-models 4 and 5 are lower than the lower limit 340, and the integer solution will be lower, and thus there is no need to continue the branch solution. The sub-model 6 has no solution. In summary, the optimal solution of the mixed integer programming model is x₁=4, x₂=2, and the optimal target value is 340. The optimal solution of the mixed integer programming model is the production planning scheme.

In order to increase the speed of solving, the kinds of products with no intersection of production materials may be divided into groups to solve the mixed integer programming model, and calculation results can be combined after separate calculations. This can reduce complexity of the model, increase calculation speed of solving the model and shorten the time to solve the model. The solution results include an optimal output of each product (from which the usage amount of each production material and the remaining inventory can be calculated), as shown in the following table 6.

TABLE 6

| Product | Optimal | Material | usage | |
|---|---|---|---|---|
| ID | output | ID | amount | inventory |
| A | 123456 | a1 | 45678 | 785 |
| B | 23456 | a2 | 89654 | 0 |

In one specific example, mixed integer programming solvers Cplex, Gurobi, SCIP, etc. can be used to solve the mixed integer programming model established in this embodiment.

In summary, the multi-product production planning method provided in this embodiment can accurately and efficiently implement production planning to increase the maximum output. The obtained production information includes the replaceable production materials marked with priorities of each kind of products, and the linear programming model has the constraint conditions including that the total output of the kind of products produced based on various replaceable production material is less than or equal to the maximum demand and outputs of products produced based on various replaceable production materials are decreased from high to low according to priorities of the replaceable production materials. In this way, the multi-product production planning method can be applied to complex scenarios where the production materials of one or some kinds of products include replaceable production materials in the production of multiple products, and even at least part of the replaceable production materials are used as mandatory production materials or replaceable production materials for other products at the same time. The multi-product production planning method can realize accurate and efficient production planning for the foregoing complex scenes, to increase the maximum output, thereby speeding up the closed-loop timeliness of production, supply and marketing, improving the accuracy of replying to customers' delivery date, reducing production switching losses, promoting production scheduling time and shortening the time for verification materials. Furthermore, the multi-product production planning method provided in this embodiment can further reduce complexity of the model, increase calculation speed of solving the model and shorten the time to solve the model by dividing kinds of products without intersection of production materials into different groups.

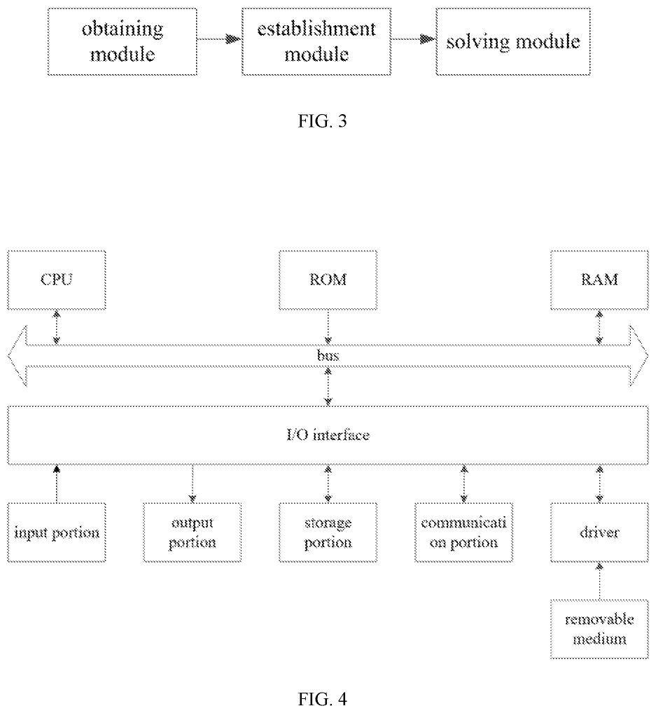

As shown in FIG. 3, another embodiment of the present application provides a multi-product production planning device, including:

an obtaining module configured to obtain production information; where the production information includes a maximum demand for each kind of products in a variety of kinds of products, types and quantities of production materials of a single piece of each kind of products, and an inventory of each production material; among the variety of kinds of products, at least two kinds of products have at least one identical production material, and the production materials of at least one kind of products includes replaceable production materials marked with priorities;

an establishment module configured to establish a linear programming model according to the production information; where a goal of the linear programming model is to maximize a total output of multiple products, and constraint conditions of the linear programming model include: usage amount of each production material is less than or equal to the inventory; an output of each kind of products is less than or equal to a maximum demand, where for one kind of products having production materials including replaceable production materials, a total output of the products produced based on each replaceable production material is less than or equal to the maximum demand; for one kind of products having production materials including replaceable production materials, outputs of products produced based on various replaceable production materials are decreased from high to low according to priorities of the replaceable production materials; and

a solving module configured to solve the linear programming model to obtain a production planning scheme.

In one possible implementation, the production information further includes a weight of each kind of products, and an objective function of the linear programming model is:

$$max {\sum }_{i = 1}^{n} {w}_{i} * {x}_{i}$$

where wᵢ represents a weight of an i-th product; xᵢ represents an output of the i-th product; n represents the number of kinds of product.

In one possible implementation, when establishing a linear programming model, the establishment module is configured to,

divide kinds of products without intersection of production materials into different groups, and establish a mixed integer programming model corresponding to each group.

In one possible implementation, the linear programming model is a mixed integer programming model.

In one possible implementation, when solving the linear programming model, the solving module is configured to,

solve the mixed integer programming model and determine whether an output of each kind of products in an obtained initial solution is an integer;

if yes, end the calculation procedure;

if not, select one of non-integer outputs in the initial solution in turn and perform a branch solution until an output of each kind of products is an integer; where when performing each branch solution, a total output value in a solution obtained in a previous branch solution is set as an upper limit of a maximum total output, and the remaining non-integer output is re-solved according to an adjacent integer value of the selected non-integer output.

It should be noted that the principle and operation flow of the multi-product production planning device provided in this embodiment are similar to the foregoing multi-product production planning method, and the relevant parts may be referred to the foregoing description, and will not be repeated here.

As shown in FIG. 4, a computer system suitable for implementing the multi-product production planning device provided in the foregoing embodiment includes a central processing unit (CPU), which may execute various appropriate actions and processes in accordance with a program stored in a read-only memory (ROM) or a program loaded into a random access memory (RAM) from a storage portion. The RAM also stores various programs and data required by operations of the computer system. The CPU, the ROM and the RAM are connected to each other through a bus. An input/output (I/O) interface is also connected to the bus.

The following components are connected to the I/O interface: an input portion including a keyboard, a mouse etc.; an output portion including a cathode ray tube (CRT), a liquid crystal display device (LCD), a speaker etc.; a storage portion including a hard disk and the like; and a communication portion including a network interface card, such as a LAN card and a modem. The communication portion performs communication processes via a network, such as the Internet. A driver is also connected to the I/O interface as required. A removable medium, such as a magnetic disk, an optical disk, a magneto-optical disk, and a semiconductor memory, may be installed on the driver, to facilitate the retrieval of a computer program from the removable medium, and the installation thereof on the storage portion as needed.

In particular, according to an embodiment of the present disclosure, the process described above may be implemented in a computer software program. For example, an embodiment of the present disclosure includes a computer program product, which includes a computer program that is tangibly embedded in a machine-readable medium. The computer program includes program codes for executing the method as illustrated in the flow chart. In such an embodiment, the computer program may be downloaded and installed from a network via the communication portion, and/or may be installed from the removable media. The computer program, when executed by the CPU, implements the functions as defined by the methods of the present disclosure.

The flowcharts and block diagrams in the figures illustrate architectures, functions and operations that may be implemented according to the system, the method and the computer program product of the various embodiments of the present disclosure. In this regard, each block in the flowcharts and block diagrams may represent a module, a program segment, or a code portion. The module, the program segment, or the code portion includes one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

The described units or modules involved in the embodiments of the present application may be implemented in software or hardware. The described unit or module may also be provided in the processor, for example, it may be described as: a processor includes an obtaining module, an establishment module and a solving module. Names of these units or modules do not constitute a limitation on the units or modules themselves under certain circumstances. For example, the obtaining module may also be described as “a module for obtaining production information”.

In another aspect, the present application further provides a computer-readable storage medium. The computer-readable storage medium may be a computer-readable storage medium included in the electronic device described in the foregoing embodiment, or a stand-alone computer-readable storage medium which has not been assembled into the electronic device. The computer-readable storage medium stores one or more programs. The one or more programs, when executed by one or more processors, cause the one or more processors to implement:

obtaining production information; where the production information includes a maximum demand for each kind of products in a variety of kinds of products, types and quantities of production materials of a single piece of each kind of products, and an inventory of each production material; among the variety of kinds of products, at least two kinds of products have at least one identical production material, and the production materials of at least one kind of products include replaceable production materials marked with priorities;

establishing a linear programming model according to the production information; where a goal of the linear programming model is to maximize a total output of multiple products, and constraint conditions of the linear programming model include: usage amount of each production material is less than or equal to the inventory; an output of each kind of products is less than or equal to a maximum demand, where for one kind of products having production materials including replaceable production materials, a total output of the products produced based on each replaceable production material is less than or equal to the maximum demand; for one kind of products having production materials including replaceable production materials, outputs of products produced based on various replaceable production materials are decreased from high to low according to priorities of the replaceable production materials; and

solving the linear programming model to obtain a production planning scheme.

In the descriptions of the present disclosure, it needs to be understood that orientation or positional relationship indicated by the term of “center”, “up”, “down”, “front”, “rear”, “left”, “right”, “vertical”, “horizontal”, “top”, “bottom”, “inside”, or “outer”, etc., is based on the drawings, and are only for the convenience of describing the present disclosure and simplifying the description, and not intended to indicate or imply that the device or element as referred to must have a specific orientation or be constructed and operated in a specific orientation, and therefore cannot be understood as a limitation to the present disclosure.

The terms “first” and “second” are used for descriptive purposes only, and cannot be understood as indicating or implying relative importance or implicitly indicating the quantity of technical features as referred to. Therefore, the features defined by “first” and “second” may explicitly or implicitly include one or more of the features. In the descriptions of the present disclosure, unless otherwise stated, “a plurality” means two or more.

In the description of the present disclosure, it should be noted that the term of “installation”, “connected”, or “connecting” should be understood in a broad sense unless explicitly stated and limited. For example, it may be fixed or removable connection, or may be integral connection; it may be direct connection or indirect connection through an intermediate medium, or, it may be internal communication of two elements. For those of ordinary skill in the art, the specific meanings of the above terms in the present disclosure may be understood on a case-by-case basis.

In the descriptions of this specification, specific features, structures, materials, or characteristics may be combined in a suitable manner in any one or more embodiments or examples.

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

What is claimed is:

1. A multi-product production planning method, executed by a computer equipment, comprising:
obtaining production information; wherein the production information includes a maximum demand for each kind of products in a variety of kinds of products, types and quantities of production materials of a single piece of each kind of products, and an inventory of each production material; among the variety of kinds of products, at least two kinds of products have at least one identical production material, and the production materials of at least one kind of products include replaceable production materials marked with priorities;
establishing a linear programming model having a goal and constraint conditions according to the production information; wherein the goal of the linear programming model is to maximize a total output of multiple kinds of products, and the constraint conditions of the linear programming model include: usage amount of each production material is less than or equal to an inventory; an output of each kind of products is less than or equal to a maximum demand, wherein for one kind of products having production materials including replaceable production materials, a total output of the one kind of products produced based on each replaceable production material is less than or equal to the maximum demand; for one kind of products having production materials including replaceable production materials, outputs of products produced based on various replaceable production materials are decreased from high to low according to priorities of the replaceable production materials; and
solving the linear programming model to obtain a production planning scheme.

2. The method according to claim 1, wherein the production information further includes a weight of each kind of products, and an objective function of the linear programming model is:
$$max {\sum }_{i = 1}^{n} {w}_{i} * {x}_{i}$$
wherein wᵢ represents a weight of an i-th product; xᵢ represents an output of the i-th product; n represents the number of kinds of product.

3. The method according to claim 1, wherein the establishing a linear programming model, includes:
dividing kinds of products without intersection of production materials into different groups, and establishing a linear programming model corresponding to each group.

4. The method according to claim 1, wherein the linear programming model is a mixed integer programming model.

5. The method according to claim 4, wherein the solving the linear programming model, includes:
solving the mixed integer programming model and determining whether an output of each kind of products in an obtained initial solution is an integer;
if yes, ending calculation procedure;
if not, selecting one of non-integer outputs in the initial solution in turn and performing a branch solution until an output of each kind of products is an integer;
wherein when performing each branch solution, a total output value in a solution obtained in a previous branch solution is set as an upper limit of a maximum total output, and the remaining non-integer output is re-solved according to an adjacent integer value of the selected non-integer output.

6. The method according to claim 1, wherein the obtaining production information, includes:
reading the production information from a database.

7. The method according to claim 6, wherein before the obtaining production information, the method further includes:
updating the production information in the database.

8. A computer equipment, comprising: a memory, a processor, and a computer program stored on the memory and executable on the processor, wherein the processor executes the computer program to implement:
obtaining production information; wherein the production information includes a maximum demand for each kind of products in a variety of kinds of products, types and quantities of production materials of a single piece of each kind of products, and an inventory of each production material; among the variety of kinds of products, at least two kinds of products have at least one identical production material, and the production materials of at least one kind of products include replaceable production materials marked with priorities;
establishing a linear programming model having a goal and constraint conditions according to the production information; wherein the goal of the linear programming model is to maximize a total output of multiple kinds of products, and the constraint conditions of the linear programming model include: usage amount of each production material is less than or equal to an inventory; an output of each kind of products is less than or equal to a maximum demand, wherein for one kind of products having production materials including replaceable production materials, a total output of the one kind of products produced based on each replaceable production material is less than or equal to the maximum demand; for one kind of products having production materials including replaceable production materials, outputs of products produced based on various replaceable production materials are decreased from high to low according to priorities of the replaceable production materials; and
solving the linear programming model to obtain a production planning scheme.

9. The computer equipment according to claim 8, wherein the production information further includes a weight of each kind of products, and an objective function of the linear programming model is:
$$max {\sum }_{i = 1}^{n} {w}_{i} * {x}_{i}$$
wherein wᵢ represents a weight of an i-th product; xᵢ represents an output of the i-th product; n represents the number of kinds of product.

10. The computer equipment according to claim 8, wherein when establishing the linear programming model, the processor executes the computer program to implement:
dividing kinds of products without intersection of production materials into different groups, and establishing a linear programming model corresponding to each group.

11. The computer equipment according to claim 8, wherein the linear programming model is a mixed integer programming model.

12. The computer equipment according to claim 11, wherein when solving the linear programming model, the processor executes the computer program to implement:
solving the mixed integer programming model and determining whether an output of each kind of products in an obtained initial solution is an integer;
if yes, ending calculation procedure;
if not, selecting one of non-integer outputs in the initial solution in turn and performing a branch solution until an output of each kind of products is an integer;
wherein when performing each branch solution, a total output value in a solution obtained in a previous branch solution is set as an upper limit of a maximum total output, and the remaining non-integer output is re-solved according to an adjacent integer value of the selected non-integer output.

13. The computer equipment according to claim 8, wherein when obtaining production information, the processor executes the computer program to implement:
reading the production information from a database.

14. The computer equipment according to claim 13, wherein before the obtaining production information, the processor executes the computer program to implement:
updating the production information in the database.

15. A computer-readable storage medium, comprising a computer program stored thereon, wherein the program is executed by a processor to implement:
obtaining production information; wherein the production information includes a maximum demand for each kind of products in a variety of kinds of products, types and quantities of production materials of a single piece of each kind of products, and an inventory of each production material; among the variety of kinds of products, at least two kinds of products have at least one identical production material, and the production materials of at least one kind of products include replaceable production materials marked with priorities;
establishing a linear programming model having a goal and constraint conditions according to the production information; wherein the goal of the linear programming model is to maximize a total output of multiple kinds of products, and the constraint conditions of the linear programming model include: usage amount of each production material is less than or equal to an inventory; an output of each kind of products is less than or equal to a maximum demand, wherein for one kind of products having production materials including replaceable production materials, a total output of the one kind of products produced based on each replaceable production material is less than or equal to the maximum demand; for one kind of products having production materials including replaceable production materials, outputs of products produced based on various replaceable production materials are decreased from high to low according to priorities of the replaceable production materials; and
solving the linear programming model to obtain a production planning scheme.

16. The computer-readable storage medium according to claim 15, wherein the production information further includes a weight of each kind of products, and an objective function of the linear programming model is:
$$max {\sum }_{i = 1}^{n} {w}_{i} * {x}_{i}$$
wherein wᵢ represents a weight of an i-th product; xᵢ represents an output of the i-th product; n represents the number of kinds of product.

17. The computer-readable storage medium according to claim 15, wherein when establishing the linear programming model, the program is executed by a processor to implement:
dividing kinds of products without intersection of production materials into different groups, and establishing a linear programming model corresponding to each group.

18. The computer-readable storage medium according to claim 15, wherein the linear programming model is a mixed integer programming model.

19. The computer-readable storage medium according to claim 18, wherein when solving the linear programming model, the program is executed by a processor to implement:
solving the mixed integer programming model and determining whether an output of each kind of products in an obtained initial solution is an integer;
if yes, ending calculation procedure;
if not, selecting one of non-integer outputs in the initial solution in turn and performing a branch solution until an output of each kind of products is an integer;
wherein when performing each branch solution, a total output value in a solution obtained in a previous branch solution is set as an upper limit of a maximum total output, and the remaining non-integer output is re-solved according to an adjacent integer value of the selected non-integer output.

20. The computer-readable storage medium according to claim 15, wherein when obtaining production information, the program is executed by a processor to implement:
reading the production information from a database.
